(19) United States
(12) Patent Application Publication
(10) Pub. No.: US 2020/0137946 A1
(43) Pub. Date: May 7, 2020

(54) SOWING DEVICE AND CONTROL METHOD THEREFOR, AND PLANT PROTECTION UNMANNED AERIAL VEHICLE

(71) Applicant: SZ DJI TECHNOLOGY CO., LTD., Shenzhen (CN)

(72) Inventors: Zijing CHANG, Shenzhen (CN); Zhuang FENG, Shenzhen (CN); Xidi HUANG, Shenzhen (CN)

(21) Appl. No.: 16/727,587

(22) Filed: Dec. 26, 2019

Related U.S. Application Data
(63) Continuation of application No. PCT/CN2017/116998, filed on Dec. 18, 2017.

(51) Int. Cl. A01C 7/08; A01C 17/00; B64D 1/02; B64C 39/02

(52) U.S. Cl. CPC A01C 7/085; A01C 17/001; A01C 17/005; B64C 2201/128; B64C 39/024; B64C 2201/027; B64D 1/02

(57) ABSTRACT

A sowing apparatus controlling method includes obtaining a target opening size of a discharge port and a target rotational speed of a turntable, obtaining a safe rotational speed of the turntable according to the target opening, and controlling a next-instance rotational speed of the turntable and a next-instance opening size of the discharge port according to the target rotational speed and the safe rotational speed.

### CROSS-REFERENCE TO RELATED APPLICATION

This application is a continuation of International Application No. PCT/CN2017/116998, filed Dec. 18, 2017, the entire content of which is incorporated herein by reference.

### TECHNICAL FIELD

The present disclosure relates to sowing controls via a plant protection unmanned aerial vehicle, and in particular to a sowing apparatus, a method of controlling the same, and a plant protection unmanned aerial vehicle.

### BACKGROUND

Plant protection unmanned aerial vehicles are employed as pilot-less airplanes in agriculture and forestry protection operations, to effect long distance remote operations, and to help solve issues on high labor intensity, low work efficiency, and uneven sowing often associated with traditional sowing based on human labor.

Certain existing plant protection unmanned aerial vehicles include flight platform (such as fixed wing aircrafts, helicopter aircrafts, and multi-axis aircrafts), a sowing device positioned underneath the flight platform, and a navigation flight control in engagement with ground controls, to deliver sowing of solids such as seeds, medicine, and fertilizer. The sowing device that may be used to discharge solids generally includes a material container, a mixer unit positioned inside of the material container, a discharge adjustment unit positioned inside of the material container, and a discharge unit positioned underneath a discharge port. The mixer unit includes a tunnel fan and a tunnel shell, and an air outlet of the tunnel shell is directed toward a bottom of the material container, to effect material mixing inside of the material container. The discharge adjustment unit includes a closable cover positioned at the discharge port, a steering gear, and a connecting rod connecting both the closable cover and a gear arm of the steering gear, to effect opening size adjustment via movement of the cover relative to the discharge port via the actions of the steering gear and the connecting rod. The discharge unit includes a side panel positioned underneath the material container, a rotary table motor, a rotary table connected to the rotary table motor, the rotary table being positioned at an inner side of the side panel, a discharge port is positioned at the side panel, such that material solids exiting onto the rotary table are discharged out via rotation of the rotary table driven by the rotary table motor.

In operation, and when the plant protection unmanned aerial vehicle is positioned at certain altitude, the rotary table motor, the tunnel fan, and the steering gear are switched on to effect discharge of material solids. However, the use of this type of existing sowing devices has been met with limitations including port blockage due to large material particles and hence uneven distribution of the material solids as discharged.

### SUMMARY

In accordance with the disclosure, there is provided a method of controlling a sowing apparatus, the method including obtaining a target opening size of a discharge port and a target rotational speed of a turntable, obtaining a safe rotational speed of the turntable according to the target opening size, and controlling a next-instance rotational speed of the turntable and a next-instance opening size of the discharge port according to the target rotational speed and the safe rotational speed.

Also in accordance with the disclosure, there is provided a sowing apparatus including a material container including a discharge port positioned at a lower portion of the material container, an opening size adjustment unit including a baffle and a baffle motor, the baffle being positioned at and movable relative to the discharge port, and baffle motor being to drive the baffle to move relative to the discharge port to adjust an opening size of the discharge port, and a discharging unit including a turntable positioned at a lower portion of the baffle and a turntable motor to drive the turntable, and a processor configured to obtain a target opening size of the discharge port and a target rotational speed of the turntable, to obtain a safe rotational speed according to the target opening size, and to control a next-instance rotational speed of the turntable and a next-instance opening size of the discharge portion according to the target rotational speed and the safe rotational speed.

Also in accordance with the disclosure, there is provided a plant protection unmanned aerial vehicle including a vehicle body, a vehicle arm, a power assembly, two end portions of the vehicle arm being respectively connected to the vehicle body and the power assembly, wherein the plant protection unmanned aerial vehicle further comprises a sowing apparatus positioned at a lower portion of the vehicle body, and the sowing apparatus includes a material container including a discharge port positioned at a lower portion of the material container, an opening size adjustment unit including a baffle and a baffle motor, the baffle being positioned at and movable relative to the discharge port, and baffle motor being to drive the baffle to move relative to the discharge port to adjust an opening size of the discharge port, a discharging unit including a turntable positioned at a lower portion of the baffle and a turntable motor to drive the turntable, and a processor configured to obtain a target opening size of the discharge port and a target rotational speed of the turntable, to obtain a safe rotational speed according to the target opening size, and to control a next-instance rotational speed of the turntable and a next-instance opening size of the discharge portion according to the target rotational speed and the safe rotational speed.

### BRIEF DESCRIPTION OF THE DRAWINGS

Objectives, features, and advantages of the embodiments are more readily understandable in reference to the accompanying drawings described below. In the accompanying drawings, the embodiments are described without limiting the scope of the present disclosure.

FIG. 1 is a schematic diagram showing a front view of a plant protection unmanned aerial vehicle according to an embodiment of the present disclosure.

FIG. 2 is a schematic diagram showing a side view of a plant protection unmanned aerial vehicle according to an embodiment of the present disclosure.

FIG. 3 is a schematic diagram showing a sowing apparatus of a plant protection unmanned aerial vehicle according to an embodiment of the present disclosure.

FIG. 4 is a schematic diagram of an opening size adjustment unit and a turntable of the sowing apparatus depicted in FIG. 3.

FIG. 5 is a schematic flow chart diagram showing a method of controlling a sowing apparatus according to an embodiment of the present disclosure.

FIG. 6 is a schematic flow chart diagram showing a method of controlling sowing operations using a plant protection unmanned aerial vehicle according to an embodiment of the present disclosure.

### DETAILED DESCRIPTION OF THE EMBODIMENTS

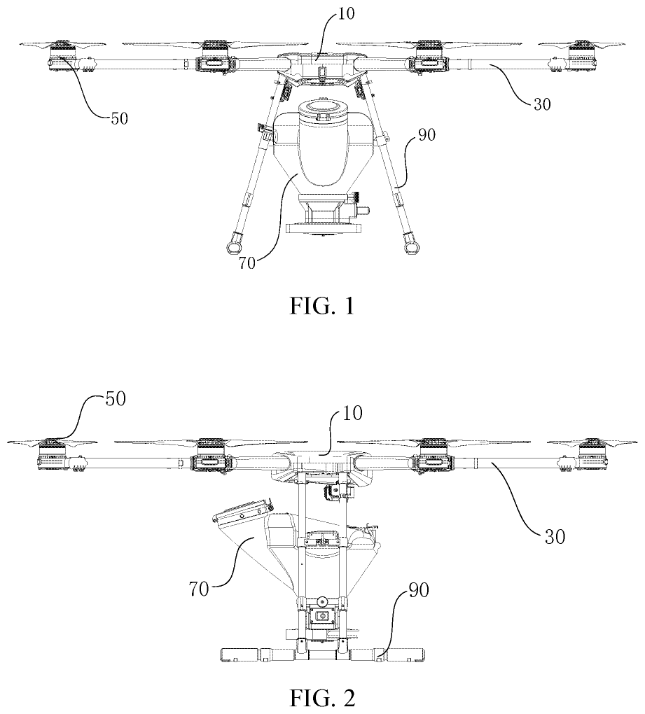

FIG. 1 is a schematic diagram showing a front view of an unmanned aerial vehicle according to an embodiment of the present disclosure, and FIG. 2 is a schematic diagram showing a side view of an unmanned aerial vehicle according to an embodiment of the present disclosure. Particular structures and collaboration among several components of the unmanned aerial vehicle are described below, to enable understanding of how a sowing apparatus of the unmanned aerial vehicle is managed and controlled.

In reference to FIG. 1 and FIG. 2, the unmanned aerial vehicle includes a vehicle body 10, a vehicle arm 30, a power assembly 50, and a sowing apparatus 70 positioned below the vehicle body 10. The vehicle body 10, the vehicle arm 30, the power assembly 50, and the sowing apparatus 70 are described below in this order.

The vehicle body 10 includes an outer shell and a flight controller positioned within the outer shell. The outer shell may be made of plastic or metal materials, and include in general an upper panel, a lower panel, and a side panel, where the side panel includes an upper end connected to the upper panel and a lower end connected to the lower panel, and the side panel together with the upper and lower panels forms a storage cavity to receive therein a flight controller. The upper panel and the lower panel may each be of any suitable shape, such as a rectangle, a circle, an oval, a pentagon, or a hexagon. The upper panel may be bigger than, smaller than, or equal to the lower panel in surface area. The side panel may be an integral panel, or a composite of multiple panel pieces. Optionally, inside of the outer shell or a cavity formed through depressions into the lower panel is installed an electrical source to provide electricity for the flight controller. Provided below is a description of the sowing apparatus 70 positioned below and connected to the lower panel via a connector such as a buckle or a screw. Alternatively, when a tripod is provided below the lower panel to support the vehicle body 10 during landing, the sowing apparatus 70 may be connected to the tripod 90 via a connector such as a buckle.

The vehicle arm 30 is connected at one end to the vehicle body 10 and at another end to the power assembly 50. The vehicle arm 30 may be in the shape of circle or an oval in cross-section, or of any other suitable hollow tubular structures. The vehicle arm 30 may be made of a plastic, a metal, or a carbon material. One or more vehicle arms 30 may be employed. For example, and when only one vehicle arm 30 is employed, the vehicle arm 30 may be connected to the upper panel of the vehicle body to form a helicopter type plant protection unmanned aerial vehicle. For example also, and when multiple vehicle arms 30 are employed, the multiple vehicle arms 30 may extend out from the vehicle body 10 along a radial direction, to form a multi-rotor type of plant protection unmanned aerial vehicle. Optionally, the multiple vehicle arms 30 extending out of the vehicle body 10 in the radial direction may be configured to be retractable relative to the vehicle body, to provide storage and transportation efficiency for the plant protection unmanned aerial vehicle as a whole.

The power assembly 50 includes a propeller, an electric motor to generate pull via driving the propeller to rotate, and an electric speed control to control operation parameters of the electric motor such as parameters on rotational speed, steering, and acceleration. For multi-rotor plant protection unmanned aerial vehicles, for example, the vehicle arm 30 includes an installation seat positioned away from the vehicle body, the propeller is connected to a top portion of the installation seat, the electric motor is seated inside of the installation seat, the electric speed control is installed at a bottom portion of the installation seat and is connected to the flight controller and the electric power respectively via a connecting line and electric line. Alternatively, the electric speed control may also be housed inside a cavity of the vehicle arm 30 or inside of the outer shell of the vehicle body 10 and is connected to the electric motor via a communication cable. When the vehicle arm 30 is of a hollow tubular shape, lines connecting electric components may be received inside of a cavity defined by the hollow tubular structure of the vehicle arm 30, to avoid unwanted exposure of the connecting lines and to improve safety and service life.

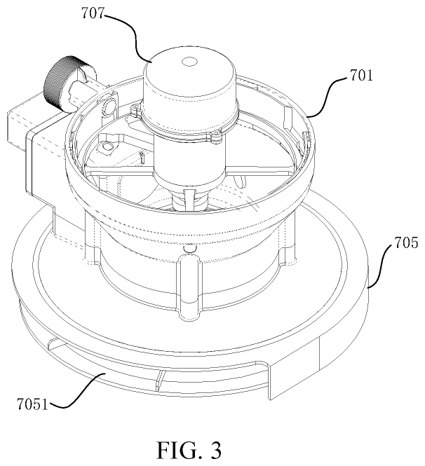

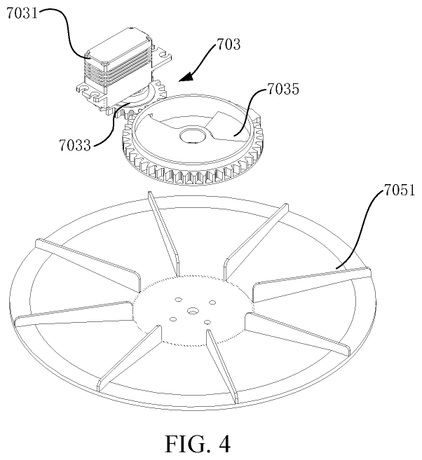

FIG. 3 is a schematic structural diagram of a sowing apparatus, and FIG. 4 is a schematic structure diagram of an opening size adjustment unit and a turntable of the sowing apparatus depicted in FIG. 3. In reference to FIG. 3 and FIG. 4, the sowing apparatus 70 includes a material container 701, an opening size adjustment unit 703, a discharge unit 705, and a processor. To provide greater clarity, description is provided below to the material container 701, the opening size adjustment unit 703, the discharge unit 705, and a processor, in this order.

The material container 701 may be of any suitable shape, such as of a cone or a rectangle in shape, or any other irregular shape. A material inlet is positioned at a top portion of the material container, and material solids such as seeds, fish food, or fertilizer may enter the material container 701 through the material inlet. A cover may be positioned above the material inlet via detachable connection such as card access or screw access, such that the cover may be detached prior to material addition and reattached after material addition is completed. A material outlet may be positioned at a bottom portion of the material container, such that material falls out of the material container via gravity once the material outlet is open.

The material container 701 may be configured to work with a mixer unit 707. The mixer unit 707 may include a mixer motor, a transmission component, and one or more mixer rods. An output shaft of the mixer motor is connected to an input end of the transmission component (such as a deacceleration gear), an output end of the transmission component is connected to the mixer shaft, and the one or more mixer rods are connected to the mixer shaft. The mixer rods may be straight, curved, or of any suitable shape. When multiple mixer rods are employed. The mixer rods may be positioned along an axial or a radial direction of the mixer shaft. Multiple mixer rods may be positioned at each of the axial direction and the radial direction of the mixer shaft to enhance mixing capacity.

The mixer unit 707 may be of any suitable mixing pattern. For example, the mixer motor drives the mixer rod to move in an up-and-down motion to mix up the material via a transmission component, where a drive gear is positioned on the output shaft of the mixer motor to be in meshing engagement with a gear structure positioned on a mixer shaft. In certain other embodiments, the electric motor may move the mixer rod via a transmission component (for example, a driving gear positioned on an output shaft of the mixer motor and a driven gear positioned on the mixer shaft and in engagement connection to the driving gear) for the mixer rod to rotate on a plane parallel or with an angle to the horizontal plane, and to cause the material solids to mix. When the mixer rod rotates on the plane at an angle to the horizontal plane, force is accordingly imparted onto the movement of the materials solids in their departure out of the discharge port, and material discharging may thus be expedited. In certain other embodiments, and via transmission components such as a three-axis gimbal, the mixer motor may cause the mixer rod to move in an irregular motion to mix up the material solids. The transmission components may include deacceleration parts such as multi-stage reduction gear to reduce speed imparted onto the mixer shaft.

The mixer unit 707 may include a tunnel positioned inside of the material container 701 and a fan positioned inside of the tunnels. Gaps are present at a lower portion of the tunnel and at a lower portion of the material container 701. The fan is with its air outlet directed at the lower portion of the material container 701 such that air from the fan moves from the lower portion of the tunnel into the material container 701 to effect mixing of the material. In certain embodiments, the discharge portion positioned at the lower panel of the material container 701 may be kept away from the tunnel to effect a good mixing of the material solids inside of the mixer unit 707.

The opening size adjustment unit 703 includes a steering gear 7031, a baffle, and a transmission component connecting the steering gear 7031 and the baffle. The baffle may be positioned at an upper portion or a lower portion of the discharge port, and the baffle is compatible in shape with the discharge port.

The baffle may be configured as a circular baffle 7035 as shown in FIG. 4, where a peripheral of the baffle includes a gear structure in meshing engagement with a drive gear 7033. The drive gear 7033 may be directly connected to the output shaft of the steering gear 7031, or the drive gear 7033 may be in transmission connection with an output shaft of the steering gear 7031 via a multi-stage gear. The circular baffle 7035 is configured with a window opening, and when there is a need to adjust the opening size of the discharge port, the steering gear 7031 may drive the circular baffle to rotate to change the opening size of the discharge port when the opening size of the discharge port is defined between the window opening of the baffle and the discharge port.

The baffle may be a rectangle in shape or of fan-shaped, and be connected to an arm of the steering gear 7031 via a connector rod. To adjust opening size of the discharge port, the steering gear 7031 is switch on, the rotating shaft of the steering gear 7031 drives the steering gear arm to rotate, which in turn causes the baffle to translate or rotate to partially or completely cover the discharge port, and to effect a size change of the discharging port.

The steering gear 7031 drives the baffle to move, a current-time rotational speed or current rotational speed or current-instance rotational speed of the steering gear 7031 may be read from a sensor of the steering gear, a current-time extent or a current extent or a current-instance extent of blockage via the baffle over the discharge port and hence the current-instance opening size of the discharge port may be obtained, and accordingly operation process of the sowing apparatus 70 may be controlled.

When a servomotor is employed instead of the steering gear 7031, a current-time rotational angle or a current rotational angle or a current-instance rotational angle of an output shaft of the servomotor may similarly be obtained, and accordingly the current-instance opening size of the discharge port may be obtained. When a brush motor or a brushless motor is employed instead of the steering gear 7031, in general a sensor is employed to detect an output of the motor to obtain the current-instance rotational angle of the motor.

Alternatively, the route or the traveling distance of the steering gear arm or the baffle may be obtained via readings from a sensor to obtain level of coverage by the baffle in calculating the opening size of the discharge port. For example, and when the baffle is the circular baffle 7035 shown in FIG. 4, a level of coverage by the baffle relative to the discharge port may be obtained via a rotational angle of the circular baffle 7035 in calculating the current-instance opening size or current opening size or current-instance opening size of the discharge port. When the discharge port and the baffle are both of a rectangle in shape, the level of coverage may be obtained by a translation distance of the baffle relative to the discharge portion in calculating the current-instance opening size of the discharge port. When the discharge portion and the baffle are both fan-shaped, the level of coverage by the baffle relative to the discharge port may be obtained according to a rotational angle of the connecting rod that connects and causes the baffle to rotate, in calculating the current-instance opening size of the discharge port. Sensors employed to detect rotational angle of the output shaft of the electric motor to detect movement route or distance of the transmission components and the baffle may be any suitable sensor, such as the Hall sensors, laser sensor and infrared sensor.

Even though gears, arms and connecting rods are described here as mechanisms to connect the steering gear 7031 to the baffle, other transmission components may be used for such connections. For example, rack and pinion and ratchet and pawl may be used as alternative transmission components. For these alternative transmission components, sensors may also be employed to detect movement route or distance of one or more of the components or parts, in calculating the current-instance opening size of the discharge port.

The discharge unit 705 includes a turntable 7051 positioned below the material outlet, and an electric motor configured to drive the turntable 7051 to in turn discharge the material from the turntable. Multiple protruding ribs may be positioned on a top surface of the turntable 7051 and extending along a radial direction, to increase discharge efficiency. The electric motor may be directly, or indirectly via a transmission component, to be in transmission connection with the turntable 7051, to cause the turntable 7051 to rotate along a generally horizontal plane, such that the material arriving at the turntable 7051 through the material outlet may exit via a peripheral of the turntable 7051 onto the ground surface, the water surface, or any other receiving objects such as trees and grass. When the electric motor for the turntable 7051 is at a relatively high speed, and the turntable 7051 only requires a relatively lower speed, the transmission component may include deacceleration part to decrease the rotational speed of the turntable 7051.

The turntable 7051 electric motor may be a servomotor, a brush motor, a brushless motor, or any other suitable motor. To achieve more accurate control on the sowing operation, rotational sensors may be employed to obtain the rotational speed of the turntable 7051, and alternatively rotational angle of the electric motor may be employed also in the calculation of the rotational speed of the turntable 7051. When the rotational speed of the turntable 7051 is obtained via the rotational angle of the electric motor, and in particular when a servomotor is used as the electric motor, data on the rotational angle or rotational speed of the servomotor may be obtained via a processor to be described in more details below. When a brush motor or a brushless motor is used as the electric motor, sensors such as the Hall sensors may be used to obtain data on the rotational angle or the rotational speed of the brush motor or the brushless motor.

To avoid material from flying out due to gravity to hit the material container 701 or the vehicle body 10, a baffle may be positioned above the turntable to be in fixed position or in rotational engagement with the turntable. To further manage material discharge from a rear of a flying direction of the plant protection unmanned aerial vehicle, a side panel may be positioned at a bottom portion of the material container 701, where the side panel together with the turntable 7051 forms a cavity with an opening, such that when the turntable 7051 rotates, the material arriving at the turntable from the material outlet is discharged from the opening onto the ground surface, the water surface, and any other objects.

When the mixer unit 707 employs the mixer rod for mixing, the mixer unit 707 and the discharge unit 705 may share an electric motor. For example, via using the same electric motor positioned above the material container 701 as shown in FIG. 3, the mixer rod of the mixer unit and the turntable 7051 of the discharge unit 705 may rotate coaxially. When the mixing speed differs from the discharging speed, deacceleration parts may be installed onto an output shaft to the turntable 7051 or to the mixer rod.

The processor includes a chip that can execute at least the following-mentioned steps. In particular, the processor may execute according to the executable programs from the storage or may execute according to a logical operation circuit. When executing the following steps, the processor may work in the capacity of a back end, or present to the user via a graphical interface, or may partly work in the capacity of a back end and partly present via a graphical interface. In executing the steps, the processor may function automatically, or partly automatically and partly with human input.

The processor may be installed onto the material container, the remote controller, or the server, or may be integrated into the flight controller of the vehicle body 10. The processor processes the information as obtained, controls the opening size adjustment unit and the discharge unit according to the processed information, and accordingly reduces issues of uneven material distribution associated with blockage at the discharge port of the sowing apparatus 70 due to large particle size of the material particles, and accordingly elicits greater control on the sowing operation.

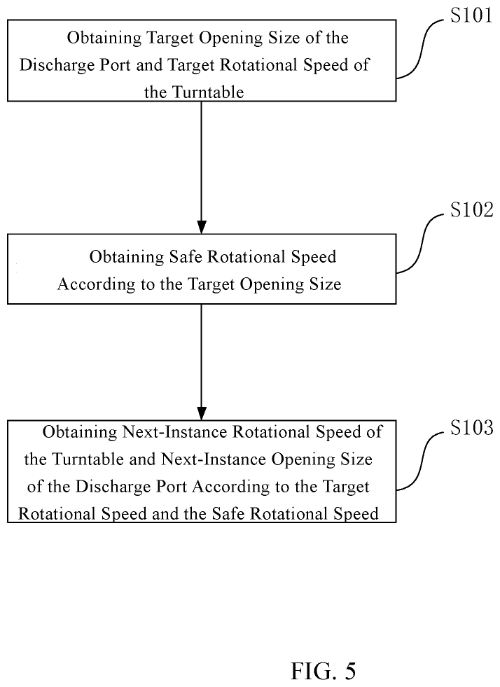

The processor and the flight controller are integrated as an “integrated flight controller” for the following description relating to a method of controlling the sowing apparatus 70 in view of FIG. 5.

In reference to FIG. 5, a method of controlling the sowing apparatus includes the following steps.

At step 101, the target opening size of the discharge port and the target rotational speed of the turntable are obtained.

In certain embodiments, the target opening size of the discharge port and the target rotational speed of the turntable may be inputted by a user. For example, the user may input an instruction via an external input device, the instruction is delivered to the integrated flight controller via the input device, the integrated flight controller in turn obtains from the instruction information on the target opening size and the target rotational speed as inputted by the user.

In certain embodiments, the target opening size of the discharge port and the target rotational speed of the turntable may be prestored in the memory of the integrated flight controller or in the memory of an external storage. The integrated flight controller reads from the internal memory or the external memory to obtain the target opening size and the target rotational speed. For example, research or agricultural service entities may store in a server information on material types, particle sizes, target opening sizes of the discharge port, and target rotational speeds of the turntable. The integrated flight controller may access the server, retrieve information stored in the server, and obtains the target opening size and the target rotational speed of a current-time sowing project or a current sowing project or a current-instance sowing project. Because these research and agricultural service entities often are in possession of the most current technologies in agricultural plantation, greater accuracy on sowing density may be obtained from these entities, and hence much improved agricultural production efficiencies.

At step S102, the safe rotational speed is obtained according to the target opening size.

In particular, the safe rotational speed, which is the minimum rotation speed of the turntable at the target opening size, may be obtained based on the target opening size of the discharged port according to a preset formula. For example, linear equations, calculus equations and any other suitable mathematical equations may be employed to calculate the safe rotational speed corresponding to the target opening size. In certain other embodiments, the safe rotational speed may be obtained from a preset data table that correlates the safe rotational speed values with the target opening size values. For example, correlations between target opening size values and safe rotational speed values may be stored in the memory of the integrated flight controller, and when the integrated flight controller receives the target opening size of the discharge port, the corresponding safe rotational speed may be obtained from the correlations stored in the integrated flight controller. Any suitable methods, such as sequential search, difference search, or binary search, may be used to conduct a lookup in the stored correlations for the safe rotational speed that is corresponding to the target opening size of the discharge port.

In certain embodiments, when the target opening size is greater than half of the maximum opening size, the safe rotational speed may be a constant; and when the target opening size is smaller than or equal to the half of the maximum opening size, the safe rotational speed is set to be in linear relationship with the target opening size, where the maximum opening size is the opening size when the discharge port is open to its maximum state or is open to its entirety. For example, when the maximum opening size of the discharge port is 1, and when the target opening size is smaller than or equal to 0.5, the safe rotational speed may be 3 times the target opening size, and when the target opening size is greater than 0.5, the safe rotational speed may be a constant of 1.5.

At step S103, next-time rotational speed or next-instance rotational speed of the turntable and a next-time opening size or next-instance opening size of the discharge port are controlled according to the target rotational speed and the safe rotational speed.

When the safe rotational speed is obtained according to the target opening size, the safe rotational speed is compared to the target rotational speed, and if the target rotational speed is smaller or slower than the safe rotational speed, an alarm signal is sent, to provide time and energy efficiencies for the control process. For example, the integrated flight controller controls the indicator light installed on the vehicle body 10 or the remote controller to be opened or closed or flickering, as a form of the alarm signal. For example also, the integrated flight controller may control a buzzer as installed on the vehicle body 10 or the remote controller to emit alarm sounds, as a form of the alarm signal. For example also, the integrated flight controller may control a display screen installed on the remote controller to display alarm text, as a form of the alarm signal. At these times, the integrated flight controller further controls the baffle positioned at the discharge port to cover the discharge port such that the discharge port is kept closed.

In certain other embodiments, when the safe rotational speed is obtained according to the target opening size, the current-instance rotational speed of the turntable is also obtained, and the current-instance rotational speed (for example at time “T”) is compared to the target rotational speed, and the result of the comparison is used to control the next-instance rotational speed (for example at time “T+1”) and the next-instance opening size of the discharge port. For example, and according to the result of the comparison, the turntable is controlled to be switch on, to accelerate, to deaccelerate, or to stop; and accordingly the discharge port is controlled from being closed to gradually opened up, the opening size of discharge port is increased or decreased, or the discharge port is changed from the open state to the close state. When the rotational speed of the turntable is set to the target rotational speed, certain irregularities may be avoided. For example, although the target rotational speed may be matched to the target opening size, the target rotational speed may be beyond the maximum rotational speed of the turntable possibly achievable by the first drive, or the turntable fails to achieve the target rotational speed due to mechanical failure. By avoiding these irregularities, safety and reliability of the sowing apparatus 70 may thus be improved.

In general, when the current-instance rotational speed at time T is smaller or slower than the target rotational speed, the discharge port is kept closed, while the turntable is accelerated via the first drive in transmission connection with the turntable.

The drive source to the first drive may be an electric motor, including but not limited to a brush motor, a brushless motor, and a servomotor, where the turntable may be accelerated, deaccelerated, or kept at a constant speed via a control exerted on the output rotational speed of the electric motor. In general, and via a size control on the accelerator of the electric motor, the output rotational speed of the electric motor and hence the rotational speed of the turntable may be accordingly controlled. For example, the integrated flight controller may generate an accelerator instruction according to the target rotational speed and current-instance rotational speed of the turntable, send the accelerator instruction to the first drive, and accordingly control the output rotational speed of the electric motor. When the first drive unit is driven by other driving sources such as a steering gear or a cylinder, an output of the driving sources may be calculated via a control on the PWM wave of the steering gear or on the cycles of the cylinder, and the rotational speed of the turntable may thus be controlled.

The turntable may be feed-back controlled via a current-instance rotational speed or a current-time rotational speed or a real-time rotational speed detected at the sensor until the turntable reaches the target rotational speed via speeding.

When the current-instance rotational speed is equal to the target rotational speed, the turntable is kept at a constant rotational speed, and the discharge port is determined to be switched open or kept closed according to a comparison between the current-instance rotational speed and the safe rotational speed.

When the current-instance rotational speed of the turntable is equal to the target rotational speed, the drive source to the first drive is kept at a constant output rate to keep the turntable run at a constant speed. For example, when the drive source of the first drive is an electric motor, the integrated flight controller may instruct the electric motor to keep the accelerator at a constant, and hence to keep an output rotational speed of the electric motor also at a constant.

The integrated flight controller conducts a comparison between the current-instance rotational speed and the safe rotational speed, and controls the movement of the baffle at the discharge port according to an outcome of the comparison.

When the current-instance rotational speed is greater or faster than or equal to the safe rotational speed, the second drive is employed to drive the baffle to move relative to the discharge port, to effect a target opening size of the discharge port. When for example a steering gear functions as a driving source for the second drive, and when the integrated flight controller learns that the current-instance rotational speed is greater or faster than or equal to the safe rotational speed, the integrated flight controller sends to the steering gear a control signal to control the PWM wave duty cycle, and accordingly to control an output of the steering gear, and in turn to control the movement of the baffle positioned at the discharge port.

For example, when the discharge port and the baffle are both curved, the baffle may be designed to turn clockwise to effect an increase in opening size of the discharge port. When the integrated flight controller learns that the current-instance rotation speed of the turntable is greater or faster than or equal to the safe rotational speed, the integrated flight controller sends to the steering gear a control signal to control the PWM wave duty cycle of the steering gear, such that the steering gear in turn drives the baffle to move clockwise to release the baffle away from the covering the discharge port. The baffle's movement may be monitored in current time, the PWM wave duty cycle of the steering gear may further be controlled, to cause the baffle to arrive at a position equivalent to the target opening size of the discharge port. The integrated flight controller may send out control signal to control the switch frequency of a switch assembly of an inverter circuit of the steering gear, and to exert control on the output rotational speed of the steering gear.

When the discharge port and the baffle are both a rectangle in shape, the discharge port increases its opening size as the baffle translates along a horizontal direction. When the integrated flight controller learns that the current-instance rotational speed is greater or faster than or equal to the safe rotational speed, the integrated flight controller sends to the electric motor an instruction to control level of acceleration of the electric motor, to in turn control the translational movement of the baffle to open up more of the discharge port. The movement of the baffle may be monitored in real time or current time, the accelerator of the electric motor is further controlled, and the baffle is accordingly moved relative to the discharge port to achieve the target opening size.

When the second drive is driven by a driving source such as a cylinder, the integrated flight controller, via controlling the working parameters of the driving source, controls the movement of the baffle along a preset route about the discharge port, and to open up the discharge port. The integrated flight controller may monitor in current time the opening size of the discharge port, generates accordingly the control signal of the work parameters of the driving source, to cause the baffle to eventually arrive at a position corresponding to the target opening size of the discharge port.

An alarm signal is sent and the discharge portion is kept closed when the current-instance rotational speed is smaller or slower than the safe rotational speed. For example, the integrated flight controller controls the signal light on the body 10 or on the remote controller to be open, be closed, or being flickering, to send out the alarm signal. For example also, the integrated flight controller controls the buzzer on the vehicle body 10 or on the remote controller to broadcast alarm sound, to send out the alarm signal. For example also, the integrated flight controller controls the display on the remote controller to display alarm text to send out the alarm signal. At these times, the integrated flight controller causes the baffle to block the discharge port such that the discharge port is at a closed state.

The safe rotational speed is obtained according to the target opening size of the discharge port, then the next-instance rotational speed of the turntable and the next-instance opening size of the discharge port of the discharge apparatus 70 are obtained according to the target rotational speed and the safe rotational speed, to impart a control on the discharge operation with enhanced accuracy, and to avoid discharge blockage issues otherwise associated with a mismatch between the target rotational speed of the turntable and the target opening size of the discharge port.

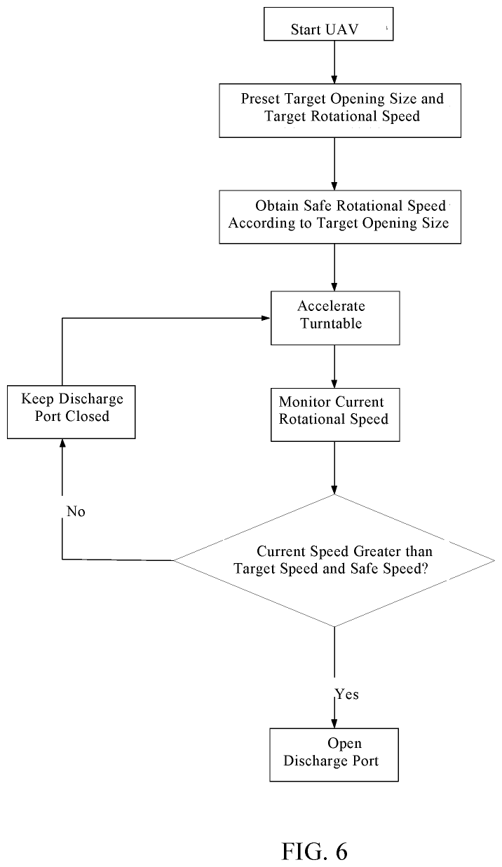

FIG. 6 is a schematic flow chart showing a method of controlling the material discharging operations using the unmanned aerial vehicle. As shown in FIG. 6, before or after the unmanned aerial vehicle is switched on, the target rotational speed of the turntable and the target opening size of the discharge port for the sowing project are inputted to the integrated flight controller via a remote controller of other input devices of the unmanned aerial vehicle. The integrated flight controller obtains the safe rotational speed, which is the minimum rotational speed of the turntable at the target opening size, according to the target opening size of the discharge port via calculations or looking up in a correlation table. The integrated flight controller obtains the current-time or current-instance (for example at time “T”) rotational speed of the turntable via a stand-alone sensor or a sensor carried by a driving source for driving the turntable, conducts a comparison between the current-instance rotational speed and the target rotational speed, and controls the next-time or next-instance (for example at time “T+1”) rotational speed according to the outcome of the comparison, such as to cause the turntable to accelerate. This process continues until the rotational speed of the turntable reaches the target rotational speed. During this process, the discharge port continues to be kept closed. When the current rotational speed of the turntable is equal to the target rotational speed, the integrated flight controller conducts another comparison between the current rotational speed and the safe rotational speed, and then controls the movement of the baffle relative to the discharge port and hence an adjustment on the opening size of the discharge port according to an outcome of the comparison. In particular, when the current-instance rotational speed is smaller or slower than the safe rotational speed, an alarm signal is sent out and the discharge port continues to be kept closed; and when the current-instance rotational speed is greater or faster than or equal to the safe rotational speed, the baffle is moved relative to the discharge port to achieve the target opening size of the discharge port.

Devices, systems, programs, and methods in actions, orders, steps, and periods, as referenced to in the present disclosure, the claims, and the drawings, may be in any suitable order. In particular, terms such as “first” and “next” may be used to simplify the task of description, but not to imply that such order is necessary.

The present disclosure is described in view of the embodiments but the embodiments as described do not necessarily limit the scope of any of the claims. Certain embodiments or features of the embodiments described herein may be combined; however, not all such combinations are necessarily required for the solutions to the disclosure. To those skilled in the technical art, many suitable changes and improvements may be made to the embodiments. Such suitable changes and improvements are understood to be included in the scope defined by the claims.

What is claimed is:

1. A method of controlling a sowing apparatus, the method comprising:
obtaining a target opening size of a discharge port and a target rotational speed of a turntable;
obtaining a safe rotational speed of the turntable according to the target opening size; and
controlling a next-instance rotational speed of the turntable and a next-instance opening size of the discharge port according to the target rotational speed and the safe rotational speed.

2. The method according to claim 1, wherein controlling the next-instance rotational speed of the turntable and the next-instance opening size of the discharge port according to the target rotational speed and the safe rotational speed comprises:
obtaining a current-instance rotational speed of the turntable; and
controlling the next-instance rotational speed of the turntable and the next-instance opening size of the discharge port according to a comparison between the current-instance rotational speed and the target rotational speed.

3. The method according to claim 2, wherein controlling the next-instance rotational speed of the turntable and the next-instance opening size of the discharge port according to the comparison between the current-instance rotational speed and the target rotational speed comprises:
when the current-instance rotational speed is slower than the target rotational speed, keeping the discharge port closed, and accelerating the turntable via a first drive, the first drive being in transmission connection with the turntable.

4. The method according to claim 3, wherein accelerating the turntable via the first drive comprises:
adjusting an accelerator of an electric motor of the first drive to accelerate the turntable.

5. The method according to claim 2, wherein controlling the next-instance rotational speed of the turntable and the next-instance opening size of the discharge port according to the comparison between the current-instance rotational speed and the target rotational speed further comprises:
when the current-instance rotational speed is equal to the target rotational speed, keeping the turntable at a constant rotational speed; and
opening up the discharge port or keeping the discharge port closed according to a comparison between the current-instance rotational speed and the safe rotational speed.

6. The method according to claim 5, wherein opening up the discharge port or keeping the discharge port closed according to the comparison between the current-instance rotational speed and the safe rotational speed comprises:
when the current-instance rotational speed is faster than or equal to the safe rotational speed, causing a baffle to move relative to the discharge port via a second drive in driving connection to the baffle positioned at the discharge port for the discharge port to open up to the target opening size.

7. The method according to claim 6, wherein causing the baffle to move relative to the discharge port via the second drive in driving connection to the baffle positioned at the discharge port comprises:
adjusting a PWM wave duty cycle of a steering gear of the second drive to move the baffle.

8. The method according to claim 5, wherein opening up the discharge port or keeping the discharge port closed according to the comparison between the current-instance rotational speed and the safe rotational speed comprises:
when the current-instance rotational speed is slower than the safe rotational speed, sending out an alarm signal and keeping the discharge port closed.

9. The method according to claim 1, wherein controlling the next-instance rotational speed of the turntable and the next-instance opening size of the discharge port according to the target rotational speed and the safe rotational speed comprises:
when the target rotational speed is slower than the safe rotational speed, sending out an alarm signal and keeping the discharge port closed.

10. The method according to claim 1, wherein obtaining the safe rotational speed of the turntable according to the target opening size comprises:
obtaining the safe rotational speed according to a preset formula or a preset correspondence table, the preset corresponding table correlating the target opening size with the safe rotational speed.

11. The method according to claim 10, wherein the safe rotational speed is a constant when the target opening size is greater than half of a maximum opening size, and wherein the safe rotational speed is in linear relationship with the target opening size when the target opening size is smaller than or equal to the half of the maximum opening size.

12. A sowing apparatus, comprising:
a material container comprising a discharge port positioned at a lower portion of the material container;
an opening size adjustment unit comprising a baffle and a baffle motor, the baffle being positioned at and movable relative to the discharge port, and the baffle motor being configured to drive the baffle to move relative to the discharge port to adjust an opening size of the discharge port;
a discharging unit comprising a turntable positioned at a lower portion of the baffle and a turntable motor configured to drive the turntable; and
a processor configured to obtain a target opening size of the discharge port and a target rotational speed of the turntable, to obtain a safe rotational speed of the turntable according to the target opening size, and to control a next-instance rotational speed of the turntable and a next-instance opening size of the discharge portion according to the target rotational speed and the safe rotational speed.

13. The sowing apparatus according to claim 12, wherein the processor is further configured to:
obtain a current-instance rotational speed of the turntable; and
control the next-instance rotational speed of the turntable and the next-instance opening size of the discharge portion according to a comparison between the current-instance rotational speed and the target rotational speed.

14. The sowing apparatus according to claim 13, wherein the processor is further configured to:
when the current-instance rotational speed of the turntable is slower than the target rotational speed, keep the discharge port closed and accelerate the turntable via a first drive in transmission communication with the turntable.

15. The sowing apparatus according to claim 14, wherein the processor adjusts an accelerator of an electric motor of the first drive to accelerate the turntable.

16. The sowing apparatus according to claim 14, wherein the processor keeps the turntable at a constant rotational speed when the current-instance rotational speed is equal to the target rotational speed, and opens up the discharge port or keeps the discharge port closed according to a comparison between the current-instance rotational speed and the safe rotational speed.

17. A plant protection unmanned aerial vehicle, comprising: a vehicle body, a vehicle arm, a power assembly, two end portions of the vehicle arm being respectively connected to the vehicle body and the power assembly, wherein the plant protection unmanned aerial vehicle further comprises a sowing apparatus positioned at a lower portion of the vehicle body, and the sowing apparatus comprises:
a material container comprising a discharge port positioned at a lower portion of the material container;
an opening size adjustment unit comprising a baffle and a baffle motor, the baffle being positioned at and movable relative to the discharge port, and the baffle motor being configured to drive the baffle to move relative to the discharge port to adjust an opening size of the discharge port;
a discharging unit comprising a turntable positioned at a lower portion of the baffle and a turntable motor configured to drive the turntable; and
a processor configured to obtain a target opening size of the discharge port and a target rotational speed of the turntable, to obtain a safe rotational speed of the turntable according to the target opening size, and to control a next-instance rotational speed of the turntable and a next-instance opening size of the discharge portion according to the target rotational speed and the safe rotational speed.

18. The plant protection unmanned aerial vehicle according to claim 17, wherein the processor is further configured to:
obtain a current-instance rotational speed of the turntable; and
control the next-instance rotational speed of the turntable and the next-instance opening size of the discharge portion according to a comparison between the current-instance rotational speed and the target rotational speed.

19. The plant protection unmanned aerial vehicle according to claim 17, wherein the processor is further configured to send out an alarm signal and keep the discharge port closed when the target rotational speed is slower than the safe rotational speed.

20. The plant protection unmanned aerial vehicle according to claim 17, wherein the processor is further configured to:
obtain the safe rotational speed according to a preset formula or a preset correspondence table, the preset corresponding table correlating the target opening size with the safe rotational speed.
